(19) United States
(12) Patent Application Publication
(10) Pub. No.: US 2014/0139323 A1
(43) Pub. Date: May 22, 2014

(54) NFC TAG AND SMART DEVICE FEATURING NFC

(71) Applicant: RESEARCH & BUSINESS FOUNDATION SUNGKYUNKWAN UNIVERSITY, Suwon-si (KR)

(72) Inventors: Hyun Seung Choo, Gwacheon-si (KR); Sung Ho Myoung, Suwon-si (KR); Tae Woo Lee, Guri-si (KR); Myoung Beom Chung, Seoul (KR); Van Phuc Nguyen, Suwon-si (KR)

(73) Assignee: RESEARCH & BUSINESS FOUNDATION SUNGKYUNKWAN UNIVERSITY, Suwon-si (KR)

(21) Appl. No.: 14/077,867

(22) Filed: Nov. 12, 2013

(30) Foreign Application Priority Data
Nov. 19, 2012 (KR) 10-2012-0130791

(51) Int. Cl. G06K 7/10; G06K 19/073

(52) U.S. Cl. CPC G06K 7/10009; G06K 19/073
USPC 340/10.51; 235/492; 235/439

(57) ABSTRACT

An NFC tag includes a storage unit that stores instructions including two or more functions received from an NFC writer or an input device, and a data exchange unit that transfers the instructions to an NFC reader. A smart device includes an NFC writer configured to input instructions including two or more functions into an NFC tag and an NFC reader configured to receive the instructions from the NFC tag. A method for inputting instructions into an NFC tag using a smart device.

### CROSS-REFERENCE TO RELATED APPLICATION

This application claims the benefit under 35 USC 119(a) of Korean Patent Application No. 10-2012-0130791 filed on Nov. 19, 2012, in the Korean Intellectual Property Office, the entire disclosures of which is incorporated herein by reference for all purposes.

### BACKGROUND

1. Field

The following description relates to an NFC tag and a smart device having an NFC communication, a method for storing instructions in the NFC tag, and a method for automatically executing those instructions.

2. Description of Related Art

The development of short-range wireless communication technologies within the IT industry, such as Bluetooth, ZigBee, radio frequency identification (RFID), and near field communication (NFC), is being actively researched and applied to various fields.

Traditional short range communication technologies are faced with various issues. For example, RFID technology can only support one way communication, and Bluetooth technology requires a lot of time for finding a connection before being capable of exchanging data. The problems experienced with Bluetooth are similarly experienced with Zigbee technology.

Unlike other technologies, NFC technology has been recently spotlighted for overcoming the problems experienced with other technologies. Typically, NFC technology uses a frequency band of 13.56 MHz for both reading and writing functionalities, thus making it possible to perform bidirectional data transmission between same or different devices. Due to relatively shorter communication distances, NFC technology is excellent in security and cost. For example, NFC is typically considered as a major communication technology in electronic payment, and can serve as an RFID reader.

With respect to examples of NFC technology, Korean Patent No. 1121440 (Title of Invention: Mobile Phone Using NFC and Control Method Thereof) describes a technique of using a plurality of NFC tags.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an NFC tag including a storage unit configured to store instructions including two or more functions received from an NFC writer or an input device; and a data exchange unit configured to transfer the instructions to an NFC reader, wherein the two or more functions are set by a preset scenario.

The two or more functions may be automatically executed according to a preset priority order by the NFC reader or a device including the NFC reader that has received the instructions.

The NFC writer or the input device may be separated from the NFC tag and configured to wirelessly input the instructions into the NFC tag.

The storage unit may store the instructions in text form.

In another general aspect, a smart device including an NFC writer configured to input instructions including two or more functions into an NFC tag; an NFC reader configured to receive the instructions from the NFC tag; and a memory configured to store a dedicated application which sets the two or more functions according to a preset scenario and controls the NFC writer.

The two or more functions may be automatically executed in response to the NFC reader receiving the instructions according to a preset priority order.

The scenario may be preset according to a location of the NFC tag.

The dedicated application may convert the instructions into text form and transfer the instructions to the NFC writer.

The dedicated application may control the smart device using the instructions so as to enable the two or more functions received through the NFC reader to be executed in the smart device according to a preset priority order.

The NFC reader may receive the instructions stored in text form in the NFC tag.

In another general aspect, a method for inputting instructions into an NFC tag, including setting, using a dedicated application of a smart device, two or more functions to be executed according to a preset scenario; controlling, using the dedicated application, an NFC writer included in the smart device so as to enable the NFC writer to transfer the instructions including the two or more functions to the NFC tag; and storing the transferred instructions using the NFC tag.

The instructions may be in text form.

The preset scenario may be preset according to a location of the NFC tag.

### BRIEF DESCRIPTION OF THE DRAWINGS

FIG. 1 is a diagram illustrating an example of an NFC tag and a smart device.

FIG. 2 is a diagram illustrating an example of a dedicated application installed in the smart device.

FIG. 3 is a diagram illustrating an example of the dedicated application installed in the smart device.

FIG. 4 is a diagram illustrating an example of a method for inputting instructions into an NFC tag.

FIG. 5 is a diagram illustrating a method for executing instructions stored in an NFC tag.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

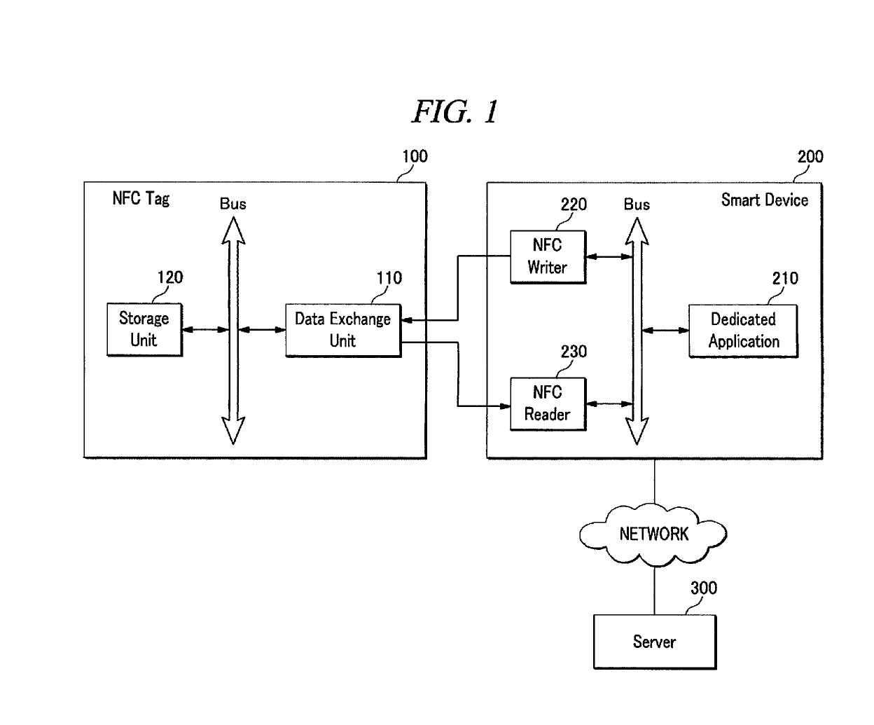

FIG. 1 illustrates an example of an NFC tag 100 and a smart device 200. Referring to FIG. 1, an NFC tag 100 includes a data exchange unit 110 and a storage unit 120.

In this example, the data exchange unit 110 of the NFC tag 100 exchanges data with an NFC writer 220 or an NFC reader 230 through near field communication. For example, the data exchange unit 110 receives instructions from the NFC writer 220 and transmits instructions stored in the NFC tag 100 to the NFC reader 230. The data exchange unit 110 conducts a contactless communication with the NFC writer 220 or the NFC reader 230 by using a frequency band of 13.56 MHz.

The storage unit 120 stores instructions received through the data exchange unit 110 from the NFC writer 220 or other smart devices which support the NFC tag 100. The received instructions may include two or more functions. In an example, the NFC tag 100 is connected to a separate device located outside, such as a bus card device, receives data directly from the input device, and stores the data in the storage unit 120. Also, the NFC tag 100 may receive data from a device including the NFC writer 220 and store the data in the storage unit 120.

The two or more functions to be stored in the storage unit 120 are set by a preset scenario. Those functions stored in the storage unit 120 are automatically executed in the NFC reader 230 or a device including the NFC reader 230 that receives instructions according to a preset priority order. The instructions including the two or more functions may be stored in text form in the storage unit 120.

The preset scenario may be related to certain circumstances which occur in a location where the NFC tag 100 is located. For example, if the NFC tag 100 is located in a meeting room, the preset scenario may be related to a circumstance that the user is having a meeting in the meeting room.

Under this circumstance, the user would set his/her smart device 200 or communication device to a vibration or silent mode and prepare materials necessary for the meeting. Accordingly, the user can define a scenario for events that occur in the location where the NFC tag 100 is located and set two or more functions according to the current scenario. That is, a scenario may be decided by a user who forecasts a circumstance that occurs in the location where the NFC tag 100 is located, and the scenario may be defined in accordance with the circumstance.

The two or more functions stored in the storage unit 120 can be automatically executed by the smart device 200 having the NFC function, which is used to communicate with the NFC tag, according to a preset priority order. The preset priority order may be decided by the user, for example, when instructions including the two or more functions are input into the NFC tag 100 through a dedicated application 210 of the smart device 200. Once the user decides the priority order for functions to be executed in the NFC reader 230, the NFC reader 230 can execute the functions according to the priority order decided by the user. In addition, if there is no decision made by the user, an absolute priority order may be preset as a default in the NFC reader 230, and functions may be executed according to the absolute priority order. In another example, a device including the NFC reader 230 may also perform the functions described as performed by the NFC reader 230.

A smart device 200 may include the NFC reader 230. If two or more functions of controlling the smart device 200 switch to silent mode and to airplane mode, the airplane mode and silent mode are executed automatically. In this case, switching to airplane mode may be a function having the most priority.

The preset scenario may vary depending on various circumstances and user settings and is not limited to the mentioned examples. Other examples for the preset scenario are described later with reference to FIG. 5.

Typically, a device which executes functions by receiving data from an NFC tag requires a plurality of NFC tags in order to execute multiple functions. However, since the NFC tag 100 stores instructions including two or more functions, the smart device 200 may execute multiple functions by using only one NFC tag 100.

In this example, the smart device 200 having an NFC function is used in interaction with the NFC tag 100. The elements similar to those of the above-described NFC tag 100 in accordance with an example of the present disclosure are denoted by the same reference numerals as used therefore. Explanation of the similar elements is omitted.

Referring to FIG. 1, the smart device 200 includes a dedicated application 210, an NFC writer 220, and an NFC reader 230.

The dedicated application 210 sets two or more functions according to a preset scenario. For example, a user can set two or more functions according to a preset scenario through the dedicated application 210.

In addition, the dedicated application 210 can control the NFC writer 220 so as to input instructions into the NFC tag 100 through the NFC writer 220. The dedicated application 210 may convert instructions into text form to transfer the data to the NFC writer 220.

The dedicated application 210 can control the smart device 200 based on the instructions received from the NFC reader 230, such that two or more functions included in the received instructions are executed by the smart device 200 according to a priority order.

For example, if the NFC tag 100 is located in an airport, the NFC tag 100 may store instructions including two or more functions set by a scenario for the airport. The two or more functions may include a function to switch the smart device 200 to vibration or silent mode, a function to disconnect wireless Internet connection, a function to disconnect a telephone call, and a function to notify callers through an automatic answering machine that the call cannot be answered.

When airplane mode is among the multiple functions and is executed first, the foregoing other functions may all be simultaneously executed as a result. Accordingly, by executing an airplane mode function, which has the top priority among the stored multiple functions, it becomes unnecessary to execute the other functions. Accordingly, when the dedicated application 210 receives instructions including two or more functions stored in the NFC tag 100, it enables the received instructions to be executed according to a preset priority order so that the smart device 200 can be effectively controlled.

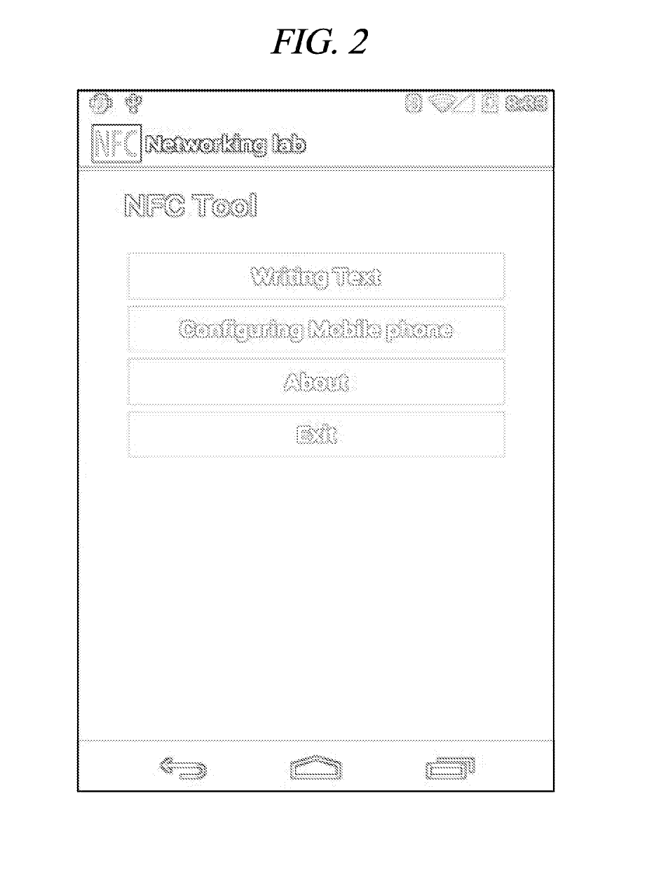

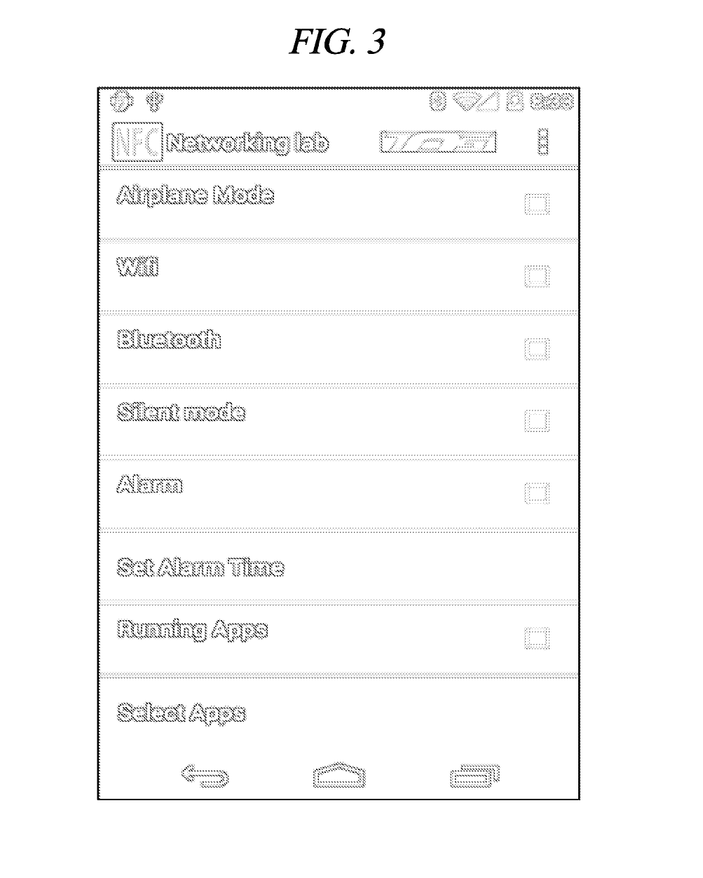

FIGS. 2 and 3 illustrate an example of a dedicated application included in a smart device.

Referring to FIG. 2, the dedicated application 210 included in the smart device 200 may input instructions into the NFC tag 100. The instructions may include two or more functions which are inputted in text form through a writing text icon. Functions within the smart device 200 can be set through a configuring mobile phone icon.

Referring to FIG. 3, it is possible to enter into a specific setting window through the configuring mobile phone icon and turn each function on or off for a user scenario. A user can selectively set each function to be on or off for a particular scenario depending on the location of the NFC tag 100 in order to input the settings into the NFC tag 100.

Referring again to FIG. 1, the smart device 200 includes the NFC writer 220. The NFC writer 220 inputs instructions including two or more functions into the NFC tag 100. Also, the smart device 200 includes the NFC reader 230. The NFC reader 230 receives instructions stored in the NFC tag 100.

In this example, by including the dedicated application 210, the smart device 200 allows its user to not only receive data but also to input instructions. That is, instructions including two or more functions set by the defined scenario or any scenario desired by the user may be input into the NFC tag 100. Accordingly, the user can serve as a data provider. In addition, since the dedicated application 210 enables the two or more functions in the instructions received from the NFC tag 100 to be executed in accordance with a priority order, it is possible to prevent an unnecessary function from being first executed so that the smart device 200 can be efficiently and effectively controlled.

An example of a method for loading instructions into an NFC tag will now be considered.

In an example, a method for inputting instructions into an NFC tag includes inputting instructions into the NFC tag 100 by using the smart device 200. The elements similar to those of the above-described NFC tag 100 and smart device 200 are denoted by the same reference numerals as used therefore.

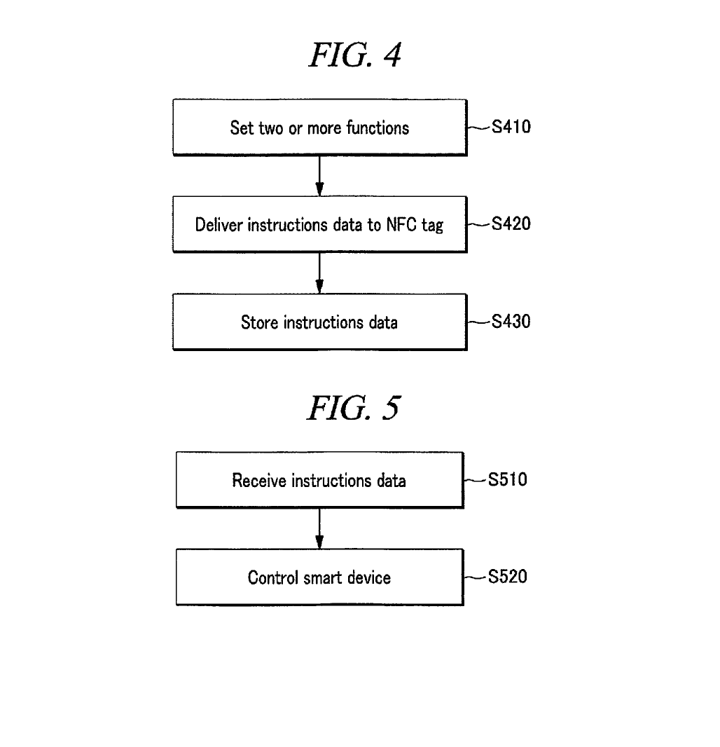

FIG. 4illustrates an example of a method for inputting instructions into an NFC tag. Referring to FIG. 4, the dedicated application 210 of the smart device 200 sets two or more functions to be executed for a preset scenario (S410).

The scenario may be preset depending on the location of the NFC tag 100. As in the above-described examples for the NFC tag 100 and the smart device 200, a user can decide the scenario by forecasting a circumstance that may occur where the NFC tag 100 is located. In addition, the dedicated application 210 can operate as the described examples with reference to FIGS. 2 and 3.

The dedicated application 210 controls the NFC writer 210 of the smart device 200 such that the NFC writer 210 transfers instructions including two or more functions to the NFC tag 100 (S420). The instructions may be in text format.

Next, the NFC tag 100 stores the transferred instructions (S430). The instructions are stored in the storage unit 120 of the NFC tag 100. In the foregoing steps S410, S420 and S430, the dedicated application 210 of the smart device 200 sets two or more functions to be executed in a preset scenario or a scenario set by a user, and the NFC writer 220 transmits the two or more functions set by the dedicated application 210 to the data exchange unit 110 of the NFC tag 100. The two or more functions received by the data exchange unit 110 of the NFC tag 100 are stored in the storage unit 120 of the NFC tag 100.

A method for executing instructions stored in an NFC tag includes enabling the instructions stored in the NFC tag 100 to be executed in the smart device 200 so as to control the smart device 200. The elements similar to those described for the above-described NFC tag 100 and smart device 200 are denoted by the same reference numerals as used therefore. Explanation of the similar elements is briefly provided or omitted.

FIG. 5 illustrates an example of a method for executing instructions stored in an NFC tag. The NFC reader 230 included in the smart device 200 receives instructions including two or more functions stored in the NFC tag 100 (S510). The instructions including two or more functions stored in the NFC tag 100 may be stored in the same manner as described with respect to the method for inputting instructions into the NFC tag 100 or directly input and stored through an external device connected to the NFC tag 100. The preset scenario may be decided based on the location of the NFC tag 100 as described above with respect to the NFC tag 100 and the smart device 200. Also, a user may set his own scenario whose type or form is not limited.

Next, the dedicated application 210 included in the smart device 200 controls the NFC reader 230 and the smart device 200 such that the two or more functions are automatically executed in the smart device 200 according to a preset priority order (S520). That is, the dedicated application 210 of the smart device 200 that has received instructions may undergo a process for first determining whether there is a priority order preset for the two or more functions. The priority order may be set by a user or an absolute priority order may be provided in the smart device 200.

The example of executing two or more functions according to a priority order has been described with reference to FIG. 1. Hereinafter, more examples of scenarios in which the NFC tag 100 and the smart device 200 can be used are described.

One example is related to use in a business trip meeting.

If the business trip meeting takes place on an airplane, the smart device 200 should be turned off or switched into airplane mode due to the problem of electromagnetic interference. This process can be simplified if an NFC tag 100 which is to activate the airplane mode is attached to the side of a seat together with a picture of an airplane.

In another example, a company holding a meeting may locate the NFC tag 100 for activation of Wi-Fi at the entrance of the company building. This may allow reinforcement of communication security for when participants of the meeting arrive. For example, when a user touches his/her smart device 200 onto the pre-input NFC tag 100 while entering into the building, the camera function may be turned off, and the Internet environment may be switched into the company's intranet, i.e., the network available only within the company. Accordingly, the user can download files necessary for the meeting through the internal network and preview contact information of people who are participating in the meeting.

In another example, a tag 100 into which a certain message has been input may be attached to a seat for each participant in a meeting place. Accordingly, important matters can be conveniently delivered. For example, the NFC tag 100 for switching to silent mode may be attached to a seat for each participant so as to encourage the participants to observe the etiquette. In addition, the NFC tag 100 may activate Bluetooth or a user-designated application during the meeting, and may enable convenient use of file transmission, memos and other data. Thus, an efficient meeting environment is provided.

Since the integrated application for providing the foregoing functions provides the functions according to the user's preference, it can be effectively used for various purposes in addition to meetings. It is possible to execute functions desired by a user through only several simple touches of a tag 100. Thus, security and user convenience is improved.

In another example, the NFC tag may be provided in a public institution or a travel agency.

When the NFC tag 100 is located at a tourist attraction and read by the smart device 200, a user can easily obtain information about the corresponding tourist attraction and peripheral information. Such information may include famous restaurants, other nearby tourist attractions, and other information. In addition, the user may access a corresponding website to upload reviews and others. Further, it is possible to provide a function for connection to a free Wi-Fi network through the NFC tag 100.

Another example includes a user reading the NFC tag 100 at the entrance of a university. In this example, the user may be allowed to access a website enabling him/her to view university information at a glance. Also, the university's wireless Internet may be accessed. Since the NFC tag 100 may contain information about its current location, a person who is new in the university can more conveniently discover geographic information of the university by using the GPS function of the smart device 200. Further, the location of the next closest one or more NFC devices may be provided. In addition, when the NFC in a location (e.g., in the library) is touched, detailed information regarding each floor of the location can be immediately obtained. Upon touching the NFC tag, the user may be connected to the Internet or the university's server 300 so that he/she can immediately view detailed information.

Another example includes using the NFC tag 100 in a home environment.

For example, parents may upload learning materials such as English words or the like on the Internet, thus making it possible for their child to read the NFC tag 100 and download such materials. In addition, if the server 300 on the Internet records when the child reads the NFC tag 100, it is possible to monitor whether a child has ever been late for school.

The foregoing examples may vary depending on various circumstances and settings by a user and are not limited to the examples described above.

In various aspects, a user or a service provider may set his/her desired functions. In addition, in view of a company, it is possible to reinforce the security issue in the NFC tag 100. If the NFC tag 100 interacts with other devices, more effective services may be provided. For example, when the NFC tag 100 is used together with a network server 300, the availability of the NFC may be broadened.

The various units, modules, elements, and methods described above may be implemented using one or more hardware components or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

What is claimed is:

1. An NFC tag comprising:
a storage unit configured to store instructions including two or more functions received from an NFC writer or an input device; and
a data exchange unit configured to transfer the instructions to an NFC reader,
wherein the two or more functions are set by a preset scenario.

2. The NFC tag of claim 1, wherein the two or more functions are automatically executed according to a preset priority order by the NFC reader or a device including the NFC reader that has received the instructions.

3. The NFC tag of claim 1, wherein the NFC writer or the input device are separated from the NFC tag and configured to wirelessly input the instructions into the NFC tag.

4. The NFC tag of claim 1, wherein the storage unit stores the instructions in text form.

5. A smart device comprising:
an NFC writer configured to input instructions including two or more functions into an NFC tag;
an NFC reader configured to receive the instructions from the NFC tag; and
a memory configured to store a dedicated application which sets the two or more functions according to a preset scenario and controls the NFC writer.

6. The smart device of claim 5, wherein the two or more functions are automatically executed in response to the NFC reader receiving the instructions according to a preset priority order.

7. The smart device of claim 5, wherein the scenario is preset according to a location of the NFC tag.

8. The smart device of claim 5, wherein the dedicated application converts the instructions into text form and transfers the instructions to the NFC writer.

9. The smart device of claim 5, wherein the dedicated application controls the smart device using the instructions so as to enable the two or more functions received through the NFC reader to be executed in the smart device according to a preset priority order.

10. The smart device of claim 5, wherein the NFC reader receives the instructions stored in text form in the NFC tag.

11. A method for inputting instructions into an NFC tag, comprising:
setting, using a dedicated application of a smart device, two or more functions to be executed according to a preset scenario;
controlling, using the dedicated application, an NFC writer included in the smart device so as to enable the NFC writer to transfer the instructions including the two or more functions to the NFC tag; and
storing the transferred instructions using the NFC tag.

12. The method of claim 11, wherein the instructions are in text form.

13. The method of claim 11, wherein the preset scenario is preset according to a location of the NFC tag.
